(19) United States
(12) Patent Application Publication
(10) Pub. No.: US 2014/0054901 A1
(43) Pub. Date: Feb. 27, 2014

(54) Sisyphean battery

(71) Applicant: John Edward Fay, Wilmette, IL (US)

(72) Inventor: John Edward Fay, Wilmette, IL (US)

(21) Appl. No.: 13/573,114

(22) Filed: Aug. 22, 2012

(51) Int. Cl. H02K 7/18

(52) U.S. Cl. 290/1 R

(57) ABSTRACT

Using creativity and prior art, this invention creates a mechanical battery that can store tremendous amounts of potential electricity, and, then, release it (as desired) so America's vast supply of clean, renewable energy (like ocean waves, lake waves, and sunlight, for example) can finally become truly reliable, and justify the enormous investment necessary to develop it to its full potential.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

This invention pertains to the field of energy storage. Specifically, it is a “mechanical” battery (in sharp contrast to a “chemistry-based” battery) that can safely store a tremendous amount of energy (perhaps enough to power an entire city for a week, or more) and then release it, as desired.

In 1831, Michael Faraday famously discovered that moving a conductor (like a copper wire) near a magnet, or, moving a magnet near the copper wire, can generate electricity. A general knowledge of this principle is all that's necessary, for a person of ordinary skill in the art, to understand the invention.

One problem the invention solves is the current technology's failure to creatively, simply, and effectively apply Michael Faraday's famous discovery to the problem of energy storage.

In bringing a “mechanical” battery into being, however, the invention also eliminates what could have been the problem of trying to develop huge-scale, “chemistry-based” batteries, to work in conjunction with America's enormous supply of renewable energy, and that, in turn, also solves the problem of trying to deal with any chemical hazards that might have been associated with such huge, “chemistry-based” batteries.

### BRIEF SUMMARY OF THE INVENTION

Nowadays, much talk is heard regarding America's need to develop clean, renewable sources of energy.

Our appetite for such energy is soaring, along with our need to attain energy independence, protect the environment, and stop sending billions of our dollars (each year) to enemies of this country, just because we (with the immense natural resources of United States) haven't yet had the wits to harness our own abundant sources of energy.

Two excellent sources of such energy are ocean (or, lake) waves and solar power, and we have vast access to both throughout the USA. But, because ocean (or, lake) waves come and go, on their own schedules, and because the availability of sunlight (and other renewable sources) can likewise be fickle, the accessibility of such energy doesn't always match up to our own timetables very well.

As a result, such resources could often produce far more energy than we could use (or store) at certain times, and, then, far less energy than we need, at others. As a result, a tremendous amount of such energy (even if initially captured) would be lost.

What America needs is an effective (and safe) way of storing this enormous amount of energy, so it can be reliably saved up (when supply exceeds demand) and, then, reliably withdrawn (when demand exceeds supply). Only then can America's enormous sources of renewable energy be regarded as truly reliable, and developed to their full potential.

Although “chemistry-based” batteries, as we know them, can be effective in storing a reasonably small amount of energy (as might be needed by one automobile car, or, one portable computer, for example) the notion of storing enough electricity to run an entire city for a week (or more) on a “chemistry-based” battery seems to require far more chemicals, and far more exposure to them, than would be practical, safe, or cost-effective.

Therefore, some creative soul needs to pick up where others have left off, and finally find a simple, effective, and safe way of building a truly huge battery, and that's what this invention is all about.

This invention doesn't involve any new scientific discoveries, per se. Rather, it simply uses creativity and prior art to finally apply Michael Faraday's famous discovery to the problem of energy storage.

### BRIEF DESCRIPTION OF THE SEVERAL VIEWS OF THE DRAWING

Seven embodiments of the invention are described in this Specification, and four drawings are presented, as well. The drawings are as follows:

FIG. 1 (which represents the “Lower Level Ball Return” for each embodiment);

FIG. 2 (which represents the “elevator” for each embodiment);

FIG. 3 (which represents the “Upper Level Ball Return” for each embodiment);

FIG. 4 (which represents balls rolling through the “inner tube”, in Embodiment 5).

Each drawing is presented in portrait orientation, with the top of the drawing at the top of the page, the bottom of the drawing at the bottom, the left side of the drawing at the left, and the right side of the drawing at the right.

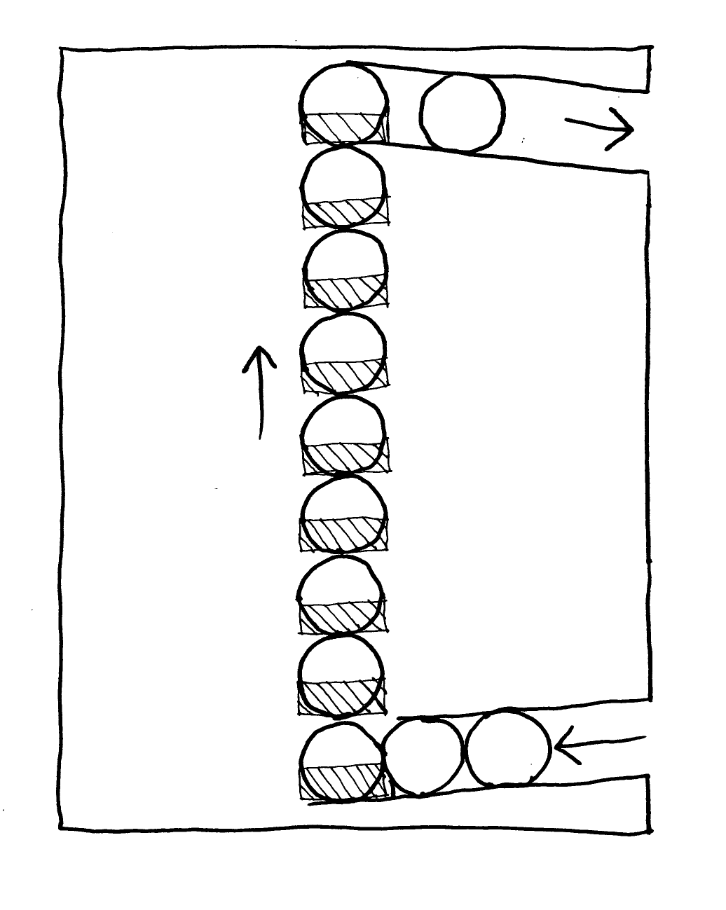

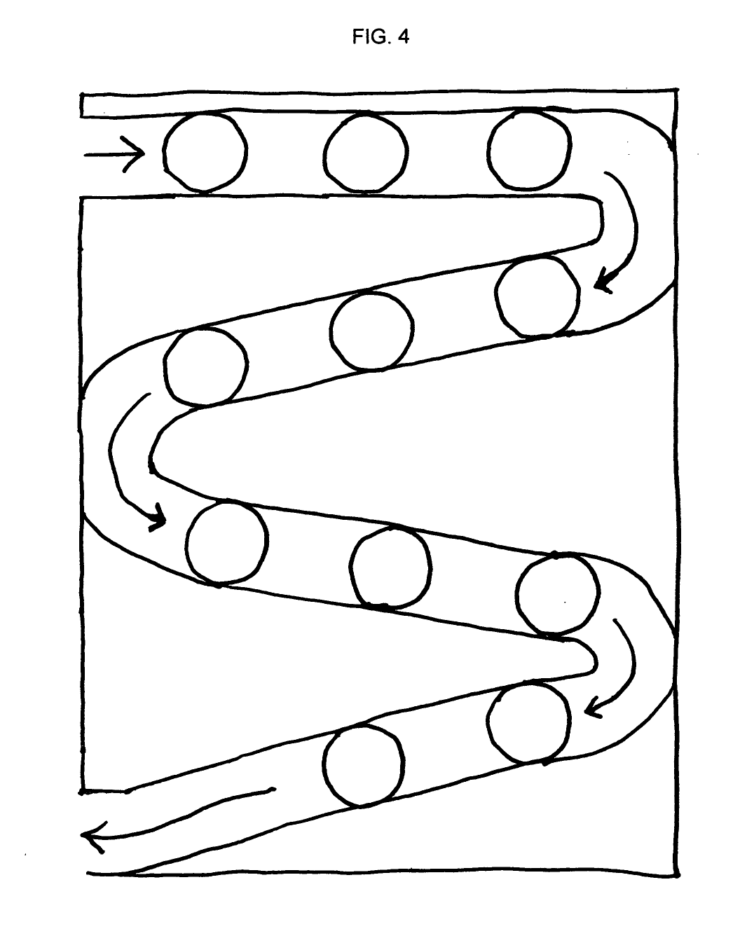

FIG. 2 and FIG. 4 should each be looked at as though the viewer were standing on level ground, or sitting on a level chair, and looking straight ahead at the drawing in question, more or less, as you would look at something in front of you in the real world.

Further, FIG. 4 is hereby defined as a “cut-away” view, by which the following is meant: FIG. 4 shows the subject matter in question as it would look if the half of the subject matter that was nearest to the viewer was cut away, and removed, such that only the half of the subject matter that was furthest from the viewer remained.

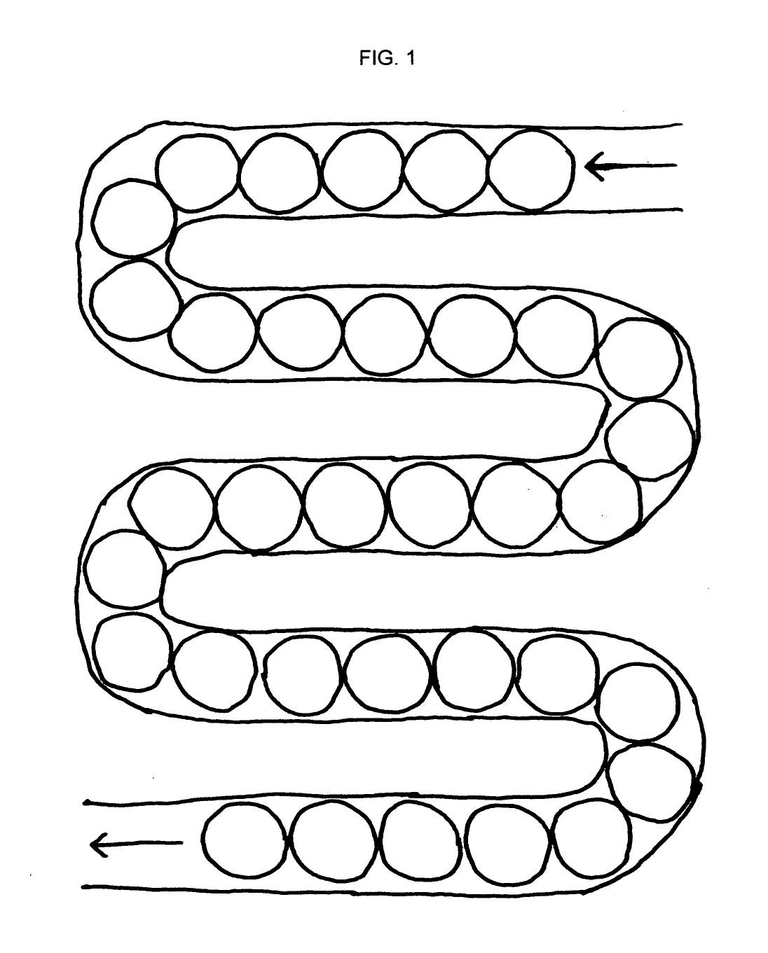

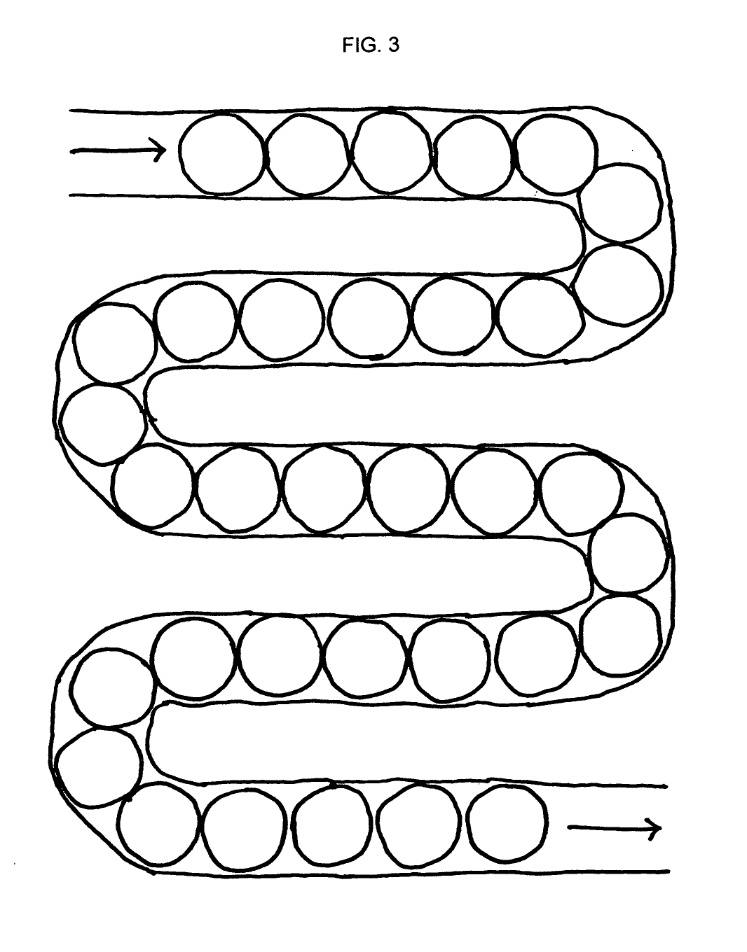

FIG. 1 and FIG. 3, however, each represent a “bird's eye” view of the subject matter depicted in them, respectively, and should be looked at as if you were positioned directly above each one of them (one at a time) and looking directly down at the one in question.

The arrows in each of the drawings indicate the direction of movement of the subject matter in question.

### DETAILED DESCRIPTION OF THE INVENTION

Embodiment 1 of the invention is described below.

The inventor originally thought of calling this invention, “The Mechanical Battery”, because it's a battery that isn't based on chemistry. But, when that name seemed too generic, and the ancient Greek myth of Sisyphus occurred to him (as being somewhat analogous to the workings of this invention) the inventor decided to name the invention, “The Sisyphean Battery”.

Sisyphus (according to the myth in question) received a punishment from the Gods, which required him to push a boulder up a hill (only to have the boulder, then, always roll back down to the bottom) such that Sisyphus found himself eternally condemned to an endless and futile task. The operations of The Sisyphean Battery, however, are not futile, and can have a very worthwhile result.

Specifically, the first part of Embodiment 1 consists of an elevator (or, conveyor belt) of sorts, which a person of ordinary skill in such arts could construct. For the purposes of Embodiment 1, it shall hereinafter be called, simply, the “elevator”.

The elevator “cars” are only lightweight little structures, which contain the minimum amount of materials necessary to safely carry their cargo (the metal balls, further described below) up to the top floor of the elevator tower, in a way that requires as little energy as reasonably possible (and, thereby, maximizes the efficiency of the elevator itself).

At the bottom floor which the elevator operates on, would be a large number of balls. These balls could be of any reasonable size, be solid or hollow, and be made of any good conductor of electricity, but, for the purposes of this description, they shall simply be the size of an average bowling ball, shall be made of pure copper, and shall be solid (as opposed to hollow).

Further, each ball could have finger holes drilled into it (like bowling balls typically have) to make them easier for workmen to handle, but, for the purposes of this description, there shall be no such finger holes.

The balls would be lined up, near the end of a “ball return”, and the end of said ball return would be in a closed position, and lead right up to the elevator itself, on the bottom floor the elevator operates on.

This ball return would largely fill the floor, and meander around said floor in a rather serpentine fashion (such that all the balls would eventually have a way of rolling along it, to its very end, near the elevator) while still leaving enough floor space, if/as necessary, to allow workmen to move around on, as they oversee the proper functioning of the invention. A bird's eye view of this “Lower Level Ball Return” is shown in FIG. 1.

The ball return in question (and the “Upper Level Ball Return”, as well, which will be spoken of later) would largely resemble the ball returns that people would have likely seen, in recent decades, in many American bowling alleys, and that a person of ordinary skill in such arts could construct.

Specifically, the ball return would be built so the balls in question could be rolled along it, at a reasonable speed, from a departure point to a destination point, and possibly include one or more small “hills”, and/or “slowing mechanisms”, of sorts, along the way, to slow down the speed of each ball, as it approached its final destination point (and/or some other particular point[s]) so the ball in question wouldn't cause a harmful disturbance upon its arrival at such point[s].

The ball returns in Embodiment 1 might also have something similar to a “railroad track” on them, consisting of two “rails” that run parallel to one another, and, if so, the metal balls in question would roll smoothly and safely along (and on top of) said railroad track (or, roll smoothly and safely by some other means, that a person of ordinary skill in such arts might construct).

In cases where the above-mentioned railroad track arrangement would be used, the two parallel rails of the track could be made of a good conductor (like copper) and/or any other materials that a person of ordinary skill in such arts might select to satisfy the necessary requirements.

One possible arrangement for the elevator, in Embodiment 1, is shown in FIG. 2.

The elevator would be connected to a standard electrical outlet, to power it, and, although the electricity from that outlet could be derived from any reasonable source (like a coal-burning power plant, for example) it shall, for the purposes of this description, only derive its electricity from these two, clean, renewable sources of energy: ocean (or lake) waves and solar power.

Thus, when the ocean (or lake) waves were raging, and/or the levels of solar energy were soaring, a tremendous amount of surplus electricity (electricity in excess of what the city in question needed) could (and would) be generated, if the city in question had a clean-energy infrastructure that was properly robust.

Rather than let all that surplus energy go to waste, a computer (which would be connected to the invention) would automatically detect that surplus electricity was being generated, and would (for that reason) turn on the elevator (“Sisyphus”) so as to make good use of said surplus electricity.

In this way, then, the elevator (as shown in FIG. 2) would put the surplus electricity to good use, by using it to lift ball, after ball, after ball, up to the top floor the elevator operates on (the top floor of the elevator tower) where each ball would then be released onto the beginning portion of the “Upper Level Ball Return”, up there.

A bird's eye view of this second ball return (the “Upper Level Ball Return”) is depicted in FIG. 3.

When the balls came off the elevator, at the top floor of the elevator tower, they would roll along the ball return up there, and become lined up near a “starting gate” (much like all the balls were originally lined up, down on the Lower Level Ball Return, near the elevator, before the elevator was turned on).

By this procedure, then, the surplus of “kinetic” energy (from the surplus of ocean/lake waves and solar power, which was present at the time, and was being turned into surplus electricity, at the city's power plant) would be wisely utilized to build up a supply of “potential” energy, as further explained below (and, said “potential” energy would then be available for release, at some future time, as desired).

As per Michael Faraday's famous discovery of 1831, electricity is induced when a conductor (like a copper ball, in this case) is moved near a magnet, or, when the magnet is moved near the copper ball.

Therefore, insofar as Embodiment 1 of the invention is concerned, the Upper Level Ball Return would lead (by a long, and winding, and slowly descending path) back down to the Lower Level Ball Return, and this “long, and winding, and slowly descending path” would be, more or less, surrounded (throughout its entire length) by a magnet, and be called the “tunnel”.

The place where the Upper Level Ball Return led into the beginning of the tunnel would be called the “starting gate”, and the place where the end of the tunnel led back into the Lower Level Ball Return would be called the “ending gate”.

The magnet in question would be in (or, would, within reason, somewhat resemble, in its effect) the shape of a common “U magnet”, except that it would be very long, and, in its length, would follow all the winding turns of the “long, and winding, and slowly descending path” in question. A “railroad track”, of sorts, would also run along the center (and throughout the length) of the “long, and winding, and slowly descending path” in question, like a railroad track runs inside (and throughout the length of) a railroad tunnel.

The “railroad track” would consist of two parallel rails of any good and workable conductor of electricity, which the balls in question could roll on, like a train rolls along a railroad track (and, for the purposes of this particular description, that conductor shall be understood to be copper) and, “railroad ties”, made of carefully chosen material (wood being but one example) that a person of ordinary skill in the art would deem appropriate.

Thus, from the point of view of a ball, as said ball rolled along the railroad track, amidst the magnet (which would be, or somewhat resemble, an upside-down U magnet, and which, for simplicity's sake, shall hereinafter be called by that name) the upside-down U magnet would, indeed, make the arrangement resemble a tunnel.

More specifically, the so-called long, upside-down U magnet would be placed so the two bends in the magnet, if any (which would be responsible for giving it a “U” shape, if it actually had one) were just above the balls, as the balls rolled through said tunnel, on the two copper rails of the railroad track.

Further, the so-called, upside-down U magnet would be positioned so its north pole would be just outside one of the two rails of the railroad track, and its south pole would be just outside the other rail of the railroad track, so that when the balls in question rolled through the tunnel, on the two copper rails of the railroad track, the north and south poles of the U magnet would be near the outside edges of the ball(s) in question. The walls thus formed by the magnet could also be made tall enough, and strong enough, to help prevent derailments of the balls, if/as desired.

The magnet in question could either be a “regular” magnet (herein defined as a magnet that isn't an electromagnet) or, it could be an electromagnet. If it was an electromagnet, the electricity to power it could either come from an auxiliary source, or, a source that initially comes from an auxiliary source, but, then, derives its power from the Sisyphean Battery itself, once the Sisyphean Battery is up and running (or, perhaps better still, by the first part of the tunnel using a “regular” magnet, which could generate enough electricity [when balls rolled through it] to power the electromagnet in use throughout the remainder of the tunnel, until the entire Sisyphean Battery was up and running, and powering its own electromagnet would be even easier).

Then, the path of the tunnel would be carefully designed, to follow a slowly descending course which would keep the balls rolling through the tunnel at some particular speed, and to keep the balls rolling for as long a time as reasonably possible.

In that way, then (as per Michael Faraday's famous discovery) the balls would induce electricity when they rolled through the tunnel, because they would be conductors moving in the proximity of a magnet.

Thus, when a time came (perhaps later during the day in question) when the ocean/lake waves calmed, and the sun went down, and the city was no longer able to generate all the power it needed, the computer connected to the invention would detect said deficiency, and, therefore, would release some of the balls stored (on the Upper Level Ball Return) into the tunnel, in carefully calculated amounts, and at carefully calculated intervals, so as to generate a steady stream of electricity, in the particular amount necessary to make up the deficiency.

When balls were thus released into the ball return, and rolled through the tunnel, they would generate the needed electricity, and it would be transmitted (through the copper railroad track[s] they were rolling on, if the invention was set up properly, by a person of ordinary skill in such art) and thus become available to supplement the city's power supply.

(In addition to, or, instead of the railroad tracks, there could be metal [or other] brushes inside the tunnel, which the rolling balls could come into contact with, as they rolled along, and these brushes could transmit the electricity being generated in the balls. Likewise, a conductor of some other kind [like a sheet of copper, or a thin copper tube, or a thin copper mesh tube] could be placed inside the tunnel, and thinly separated from the magnet [perhaps by a non-conductor] as a person of ordinary skill in the art could do, so the electricity could be transmitted through that.)

The path of the tunnel, from the starting gate (where the tunnel begins) to the ending gate (where the tunnel ends) would be carefully designed, by a person of ordinary skill in such art. This would very likely involve calculations including (but not necessarily limited to) the following:

how fast each ball should be made to roll through the tunnel, to maximize the amount of electricity it would generate;

how slight the downward angle of the tunnel should be, so as to effectuate the desired speed of each ball, while also maximizing the length of time each ball could be kept moving, with the least length of tunnel possible, to maximize the electricity generated and minimize costs;

which kind of path for the tunnel (be it the shape of an automobile racetrack, slowly descending, like cars exiting a parking garage, or otherwise) would allow for the greatest length of tunnel, and the greatest amount of electricity being generated, with the least amount of construction costs;

at what angle(s), if any, the turns (and/or other areas) of the tunnel (and the two copper tracks of its railroad track, where applicable) would have to be banked, so as to keep the balls from falling off the track, and/or smashing into the tunnel, and/or causing other problems;

what the appropriate level of strength to give the electromagnet (or, “regular” magnet, where applicable) would be, so as to maximize the amount of electricity that could be generated by the balls rolling through it, without adversely affecting the outcome in any other way(s), and while using the minimum amount of energy (in the case of an electromagnet, for example) needed to accomplish this;

all focused on making The Sisyphean Battery as efficient as possible.

Because such considerations would very likely be worthwhile, and could be very easily incorporated into many variations of The Sisyphean Battery, it should be noted that the amount of one-time capital costs devoted to the design (and, then, construction) of The Sisyphean Battery could have an enormous effect on its level of efficiency.

In other words, if each ball could be kept rolling, for example, at the optimum speed, and for the optimum duration, in a facility covering a certain number of square feet, while another facility, half the size, could also keep each ball rolling at the optimum speed, and for the optimum duration (because it includes a more efficient use of space, insofar as the particular path chosen for the tunnel is concerned) then, a great deal of money could be saved by building the smaller facility, with the more efficient use of space.

Further, while the one-time capital outlays for the construction of such a Sisyphean Battery may be significant, they might, if properly handled, yield truly excellent results, and do so for a great many years (due to the durability of the materials used, and the relative safety in using them) and thereby exceed (on both a cost and safety basis) a comparable “chemistry-based” battery system, which may, perhaps, have lower start-up costs, but, then, might prove to be much more expensive (for various reasons) over time.

Lastly, it should also be noted that there could be more than one fully installed Sisyphean Battery at work at the same time, in the same general location, or, “campus”. In other words, there could, for example, be three Sisyphean Batteries at work on the same campus, at the same time, and each of the three could be connected to one another.

In such an arrangement, the computer associated with Sisyphean Battery #1 could be connected to the computers associated with Sisyphean Battery #2, and Sisyphean Battery #3, respectively.

Then, for example, when all the balls associated with Sisyphean Battery #1 were successfully carried to the top floor of its elevator tower, the various computers could be programmed to not only stop that elevator, but (if there was still surplus electricity being produced) start the elevator associated with Sisyphean Battery #2 (and, ultimately, stop the elevator at Sisyphean Battery #2, and start the elevator at Sisyphean Battery #3, if there was yet further surplus electricity being generated).

Further still, when an insufficient supply of electricity was being generated in the city, the computer associated with Sisyphean Battery #1 could be programmed to start releasing balls into its tunnel (to generate additional electricity, in whatever amount was needed) and continue that until its balls had run through its tunnel.

Then, the network of computers in question could stop that, and trigger Sisyphean Battery #2 to release its balls into its tunnel (to continue generating the necessary amount of electricity, without a hitch) until all its balls had run through its tunnel, at which point, finally, it might stop that, and trigger Sisyphean Battery #3 to start releasing its balls into its tunnel, in the same way.

(In another arrangement, the three elevators might all be programmed to run at the same time, and, then, the three tunnels might all be programmed to run at the same time. This would enable three times as much energy to be stored per hour, and, then, enable three times as much energy to be released per hour, but, it could only be sustained for one third as long a time.)

But, to consider a simple (and specific) example, suppose there is only one Sisyphean Battery in operation, in some particular city, and suppose it's built according to the specifications for Embodiment 1 of the invention.

Suppose, further, there are 1.68 million balls in the Sisyphean Battery in question (which would be the equivalent of 10,000 balls rolling through its tunnel, at a consistent rate, for every hour of the week) and suppose those 10,000 balls rolling through its tunnel, per hour, would be enough to generate all the electricity the city needed.

Suppose, further, that all 1.68 million of the balls in question were down at the bottom floor the elevator operates on, and lined up on the Lower Level Ball Return, at 7:00 A.M., on some particular day.

Further still, suppose the ocean/lake waves then began to rage (which led to a huge surplus of electricity being generated from the ocean/lake waves) and the sunrise came without a cloud in the sky (which led to a huge surplus of electricity being generated from solar energy).

These surpluses would be detected by the computer associated with the Sisyphean Battery in question, and the computer would cause the elevator (Sisyphus) to turn on, and begin carrying balls up to the top level of the elevator tower (and begin releasing those balls onto the Upper Level Ball Return, near the tunnel's starting gate, to be held for future use).

Suppose this continued for many hours, until, at 5:00 P.M. that evening, there were 250,000 balls loaded up by the starting gate, at the top floor the elevator operates on.

Then, suppose the ocean waves started to subside (which was decreasing the amount of electricity being generated from ocean/lake waves) and the sun started going down (which was decreasing the supply of electricity being generated from solar energy) such that the amount of electricity being generated would, at some point in the future, no longer be enough to meet the demand for electricity throughout the city.

This coming deficiency would be noted by the computer associated with the Sisyphean Battery, and specifically calculated. Suppose, for example, it was determined that, based on the trend of present conditions, only 90% of the electricity needed for the city would be getting generated, by the time three more hours had passed.

(And, to keep this hypothetical example simple, suppose, further, that the tunnel for the Sisyphean Battery in question was built so it would take exactly one hour for a ball to roll through it, from the starting gate to the ending gate.)

Because (as noted earlier, in this hypothetical example) it takes 10,000 balls rolling through the tunnel, per hour, to generate 100% of the electricity needed for the city, the fact that only 90% of that electricity would be generated by ocean/lake waves and solar power, by the time three more hours had passed, would mean that a large deficiency (of 10%) would then exist, and, therefore, that a supplement of 1,000 balls rolling through the tunnel, per hour, would then be necessary to eliminate that deficiency.

In such a case, then, the computer associated with the Sisyphean Battery in question would begin opening the starting gate of the tunnel, in the precise way(s) necessary, so that 1,000 adequately-spaced balls would be rolling through the tunnel, per hour, by the time they were needed.

(Because, in actual practice, it would take a certain amount of time to release 1,000 balls into the tunnel, with adequate spacing between each ball, the computer would be programmed to always be forecasting future conditions, and always adjusting to changing present conditions, in an effort to hold supply and demand in as precise a balance as reasonably possible, in order to prevent the need to release a large number of balls over a very short period of time.)

Whenever one of the released balls finally passed a carefully calculated point, near the ending gate of the tunnel, called the “trigger point”, that event would be detected by the computer, and used to automatically trigger the release of another ball (at precisely the correct time) to replace the ball in question, such that the level of the 1,000 ball/hour supplement would be properly maintained, without causing a hitch in the amount of the electrical output.

Suppose that by 8:00 P.M., the ocean/lake waves and the sun were forecast to generate even less electricity, in the hours ahead, and everybody in the city had gotten home from work, and turned on their air-conditioners, and television sets (which increased the demand for electricity) such that only half of the electricity needed throughout the city was actually expected to be generated in the hours ahead.

In such a case, the computer associated with the Sisyphean Battery in question would be automatically detecting the forecast for declining energy production, and automatically detecting the increase in electricity consumption, and would be adjusting to the changing conditions.

Thus, by 8:00 P.M., it would have calculated that 5,000 adequately-spaced balls would need to be rolling through the tunnel, per hour, in the hours ahead, to correctly supplement the amount of electricity being generated, and it would, therefore, be opening the starting gate to the tunnel, over the period of time in question, in the ways necessary to accomplish that objective.

Lastly, suppose that by 11:30 P.M., the ocean/lake waves were raging again, and most of the television sets were off, such that 115% as much electricity as the city needed was being generated.

In such an event, the computer associated with the Sisyphean Battery would have been detecting this change in ocean/lake wave conditions, and forecasting the decline in electricity demand, over the time period in question, and would have been doing two things to adjust to it.

First, it would have been reducing the number of balls released into the tunnel, as appropriate (and, then, would have closed the starting gate to the tunnel altogether, when no more balls rolling through the tunnel were needed).

Then, it would have once again turned on the elevator (Sisyphus) so the elevator would wisely utilize the surplus electricity then being generated by the ocean/lake waves (and the balls still winding down in the tunnel, if any) by lifting ball, after ball, after ball, once again, to the top floor the elevator operates on, and gathering them on the Upper Level Ball Return.

Then, as before, there would be balls lined up by the starting gate of the tunnel, at the top floor of the elevator tower, which would be held for eventual release into the tunnel, to generate electricity, as desired.

Embodiment 2 of the invention is described below. It would be the same as Embodiment 1 (described in detail, above) except as follows.

Where Embodiment 1 of the invention had the so-called long, U shaped magnet in an upside-down position, Embodiment 2 would have the so-called long, U shaped magnet in a right-side-up position.

This would (to the extent the so-called U magnet actually had a U shape) essentially put a floor under the railroad track running through it, but the material of the railroad ties (wooden, or otherwise) would act to keep the two rails of the railroad simply conductors (rather than allowing them to become part of the magnet itself, like an iron nail touching a magnet becomes a magnet itself) if/as a person of ordinary skill in the art would deem appropriate.

Further, as in Embodiment 1, the walls formed by the so-called U magnet (one wall along the outside of each of the two rails of the railroad track) could be made tall enough, and strong enough, to help prevent derailments of the balls, if/as desired.

Embodiment 3 of the invention is described below. Embodiment 3 is the same as Embodiment 2, except as follows.

Where Embodiment 2 had the so-called long, U shaped magnet, Embodiment 3 would, instead, have a long length of insulated wire, wound into the shape of a circular coil, and an appropriate amount of electric current would be passed through said coil, to create a magnetic field around it (as a person of ordinary skill in the art could do).

The coil would likely be of as small a circumference as reasonably possibly, so the balls rolling through it, on the railroad track, would be as close to the coil as reasonably possible, so as to most efficiently induce the greatest amount of electricity in the balls rolling through it. The railroad track would be laid inside the coil, and its rails would once again be used to transmit the electricity generated by the rolling balls.

Embodiment 4 of the invention is described below. It would be the same as Embodiment 3, except as follows.

Where Embodiment 3 had a long coil of insulated wire, Embodiment 4 would also have a long coil of insulated wire, except that the coil would be wound around the outside of a structure whose shape, composition, and other characteristics were (or somewhat resembled) those of a standard, circular, metal water pipe (in the ways that a person of ordinary skill, in the electromagnetic and related arts, would deem appropriate).

Instead of being called the “tunnel”, however (as this section of the invention was called, in prior embodiments) the pipe itself (separate and distinct from the coil of insulated wire wound around the outside of it, throughout its length) would simply be called, the “tube”.

Like Embodiment 3, Embodiment 4 would have an appropriate amount of electric current passing through said coil of wire, to create a magnetic field around the tube (as a person of ordinary skill in the art could do).

The tube would likely be of as small a circumference as reasonably possibly, so the balls rolling through it would be as close to it as reasonably possible, so as to most efficiently induce the greatest amount of electricity possible, in the balls, as the balls rolled through it.

The railroad track would be laid inside the tube, and once again the two rails would act to transmit the electricity generated by the rolling balls.

Embodiment 5 is described below. It would be the same as Embodiment 4, except as follows.

Embodiment 5 would not have a railroad track, and each ball could either roll freely, on the inside surface of the [electro-magnetized] tube itself (if a person of ordinary skill in the art could get the [electro-magnetized] tube itself to conduct the electricity generated by the rolling balls, in a truly satisfactory way) or, the balls could, instead, simply roll freely on the inside surface of another tube (hereinafter called, the “inner tube”) which would be placed inside the tube itself, and somewhat thinly insulated from the tube itself, so as to not become part of the electromagnet (which includes the [elctro-magnetized] tube, itself) but, rather, simply be able to remain a good conductor, which could, in fact, transmit the electricity generated by the balls rolling within it.

The Upper Level Ball Return, in Embodiment 5, would still lead up to (or, a tiny way into) the tube (or, inner tube, where applicable) and the Lower Level Ball Return would still connect up with the end of the tube (or, inner tube, where applicable) but no railroad track would be present within the tube (or, inner tube, where applicable) itself.

Embodiment 5 would, therefore, not only eliminate the need for a railroad track inside the tube, but, also eliminate the potential problems associated with ball derailments (when balls went around turns, and/or elsewhere) and all the calculations and other obstacles necessary to try to prevent such derailments, because the balls would be totally encircled by the tube (or, inner tube, where applicable) and therefore (within reason) have no feasible means of going astray.

FIG. 4 is a cut-away view (as defined above, in the section called, “BRIEF DESCRIPTION OF THE SEVERAL VIEWS OF THE DRAWING”) of balls rolling through the inner tube, in Embodiment 5.

Embodiment 6 is described below. Embodiment 6 would be the same as Embodiment 5, except as follows.

Unlike Embodiment 5, the tube in Embodiment 6 would simply be a “regular magnetic tube”, where the term, “regular magnetic tube”, is defined as follows: “a tube which is magnetic on its own, without the need of some external force (like electricity running through a coil of insulated wire, wound around it) to give it magnetic properties.”

A railroad track (like the one present in all the embodiments of the invention mentioned earlier, except Embodiment 5, which doesn't have a railroad track at all) could run along the inside bottom of the tube, throughout the length of the tube, and transmit the electricity generated by the rolling balls. If a person of ordinary skill in the art could make the “regular magnetic tube”, itself, act as a conductor (and/or, if an inner tube was used as a conductor) the railroad track could thus be eliminated.

Embodiment 7 of the invention is described below. It is not necessarily the most practical, or efficient embodiment, but is, nonetheless, included below, in the interests of thoroughness.

Embodiment 7 would be the same as Embodiment 6, except that the conductor(s) and the magnet(s) would reverse their positions.

In other words, in Embodiment 7, the balls themselves would be the magnets, and the tube they rolled through would not be magnetic.

The tube could have a railroad track in it, like Embodiment 6 could, to transmit the electricity generated by the rolling balls, or, it could have no railroad track, and the tube itself could be the conductor, and transmit the electricity itself.

Further, steps could be taken so the rotation, of the magnetic polarity of the balls, was synchronized, as the balls rotated (rolled) through the tube, according to some particular pattern.

For example, the magnetic polarity of each ball could be synchronized, so the north pole of each ball would be facing straight up, at the same time, when the balls were rolling through the tube.

Or, the magnetic polarity of the balls could be synchronized in some kind of alternating pattern. For example, they might be synchronized so one ball's north pole would always be facing directly upward, when the next ball's north pole was facing directly downward.

Or, the magnetic polarity of the balls could be synchronized in some other arrangement, or, left totally at random, if/as desired.

The kinds of synchronizations mentioned above could be done manually, by simply marking the north pole of each ball, for example (perhaps by painting an “N” on it) and then moving each ball into the position where the “N” on it would be facing directly upward, as it arrived at some exact point (perhaps by the starting gate into the tube).

Such synchronizations could also be done automatically, by using two auxiliary electromagnets magnets, for example, at some exact point (perhaps by the starting gate of the tube) as follows.

One of the two electromagnets could be directly above the ball in question, and have a “South Pole” magnetic charge (for example) while the other electromagnet could be directly below the ball in question, and have the opposite magnetic charge (a “North Pole” magnetic charge, for example).

Further, those electromagnetic charges could be made strong enough, by a person of ordinary skill in the art, to spin each ball into the desired position, as each ball passed by the two electromagnets in question, so the polarity of all the balls would be synchronized with one another, as desired, by the polarity of the electromagnets, for the time when the balls then rolled through the tube.

The two electromagnets could be programmed to always retain the “North Pole” and “South Pole” polarities, respectively, so all the balls became likewise synchronized with one another, or, the electromagnets could be programmed to change their polarity according to some particular pattern (like always reversing themselves, for example, when the next ball comes by, so one ball would always have its north pole directly upward when the next ball would have its south pole directly upward) as a person of ordinary skill in the art could do, if/as desired.

1. The inventor, John Edward Fay, makes the independent claim that the invention, called, The Sisyphean Battery, includes at least:
one means of raising items to a relatively high height;
and, one means of lowering items, to a lower level, which causes magnet(s) to move near conductor(s), and/or conductor(s) to move near magnet(s), and thereby generates electricity;
such that potential electrical energy can be stored at a relatively high height, and, then, be released by the descent of items to a lower level, upon demand;
all occurring when the invention is properly constructed, installed, monitored, and maintained.

2. The inventor also specifically claims that Embodiment 1 of the invention is a particular species of the genus set out, generically, in claim 1, that it includes all the limitations of claim 1 (and, indeed, imposes even further limitations than claim 1) and, that it, too, can store potential electrical energy, and, then, release it, to generate electrical energy, upon demand.

3. The inventor also specifically claims that Embodiment 2 of the invention is a particular species of the genus set out, generically, in claim 1, that it includes all the limitations of claim 1 (and, indeed, imposes even further limitations than claim 1) and, that it, too, can store potential electrical energy, and, then, release it, to generate electrical energy, upon demand.

4. The inventor also specifically claims that Embodiment 3 of the invention is a particular species of the genus set out, generically, in claim 1, that it includes all the limitations of claim 1 (and, indeed, imposes even further limitations than claim 1) and, that it, too, can store potential electrical energy, and, then, release it, to generate electrical energy, upon demand.

5. The inventor also specifically claims that Embodiment 4 of the invention is a particular species of the genus set out, generically, in claim 1, that it includes all the limitations of claim 1 (and, indeed, imposes even further limitations than claim 1) and, that it, too, can store potential electrical energy, and, then, release it, to generate electrical energy, upon demand.

6. The inventor also specifically claims that Embodiment 5 of the invention is a particular species of the genus set out, generically, in claim 1, that it includes all the limitations of claim 1 (and, indeed, imposes even further limitations than claim 1) and, that it, too, can store potential electrical energy, and, then, release it, to generate electrical energy, upon demand.

7. The inventor also specifically claims that Embodiment 6 of the invention is a particular species of the genus set out, generically, in claim 1, that it includes all the limitations of claim 1 (and, indeed, imposes even further limitations than claim 1) and, that it, too, can store potential electrical energy, and, then, release it, to generate electrical energy, upon demand.

8. The inventor also specifically claims that Embodiment 7 of the invention is a particular species of the genus set out, generically, in claim 1, that it includes all the limitations of claim 1 (and, indeed, imposes even further limitations than claim 1) and, that it, too, can store potential electrical energy, and, then, release it, to generate electrical energy, upon demand.
